(19) United States
(12) Patent Application Publication
(10) Pub. No.: US 2024/0230911 A1
(43) Pub. Date: Jul. 11, 2024

(54) HIGHLY PARALLEL LARGE MEMORY HISTOGRAMMING PIXEL FOR DIRECT TIME OF FLIGHT LIDAR

(71) Applicant: Sense Photonics, Inc., Durham, NC (US)

(72) Inventors: Tarek Al Abbas, Edinburgh (GB); Robert Henderson, Edinburgh (GB)

(21) Appl. No.: 18/573,341

(22) PCT Filed: Jun. 29, 2022
(86) PCT No.: PCT/US2022/035485

§ 371 Date: Dec. 21, 2023

Related U.S. Application Data
(60) Provisional application No. 63/216,580, filed on Jun. 30, 2021.

(51) Int. Cl. G01S 17/894; G01S 7/4863; G01S 7/4865; G01S 17/931

(52) U.S. Cl. CPC G01S 17/894; G01S 7/4863; G01S 7/4865; G01S 17/931

(57) ABSTRACT

A Light Detection and Ranging (LIDAR) circuit includes a non-transitory memory device comprising a first memory and a second memory, and at least one control circuit. The at least one control circuit is configured to execute first memory storage operations to store data indicated by detection signals received from one or more photodetector elements in the first memory during a time between pulses of an emitter signal output from a LIDAR emitter element, and execute second memory storage operations to include previous data indicated by previous detection signals received from the one or more photodetector elements, which was stored in the first memory, in respective memory bins of the second memory. The first and second memory storage operations are executed at least partially concurrently. Related devices and methods of operation are also discussed.

### CLAIM OF PRIORITY

The present application claims priority from U.S. Provisional Patent Application No. 63/216,580 filed Jun. 30, 2021, in the United States Patent and Trademark Office, the disclosure of which is hereby incorporated by reference herein in its entirety.

### FIELD

The present disclosure is directed to Light Detection and Ranging (LIDAR or lidar) systems, and more particularly, to memory operations in time-of-flight lidar systems.

### BACKGROUND

Time of flight (ToF) based imaging is used in a number of applications including range finding, depth profiling, and 3D imaging (e.g., lidar). Direct time of flight (dToF) measurement includes directly measuring the length of time between emitting radiation from emitter element(s) and sensing the radiation by detector element(s) after reflection from an object or other target. From this, the distance to the target can be determined. Indirect time of flight measurement includes determining the distance to the target by phase modulating the amplitude of the signals emitted by the emitter element(s) of the lidar system and measuring phases (e.g., with respect to delay or shift) of the echo signals received at the detector element(s) of the lidar system. These phases may be measured with a series of separate measurements or samples.

In specific applications, the sensing of the reflected radiation in either direct or indirect time of flight systems may be performed using an array of photodetectors, such as an array of Single Photon Avalanche Diodes (SPADs). One or more photodetectors may define a detector pixel of the array. SPAD arrays may be used as solid-state detectors in imaging applications where high sensitivity and timing resolution may be required.

A SPAD is based on a semiconductor junction (e.g., a p-n junction) that may detect incident photons when biased beyond its breakdown region, for example, by or in response to a strobe signal having a desired pulse width. The high reverse bias voltage generates a sufficient magnitude of electric field such that a single charge carrier introduced into the depletion layer of the device can cause a self-sustaining avalanche via impact ionization. The avalanche is quenched by a quench circuit, either actively (e.g., by reducing the bias voltage) or passively (e.g., by using the voltage drop across a serially connected resistor), to allow the device to be “reset” to detect further photons. The initiating charge carrier can be photo-electrically generated by a single incident photon striking the high field region. It is this feature which gives rise to the name ‘Single Photon Avalanche Diode.’ This single photon detection mode of operation is often referred to as ‘Geiger Mode.’

When imaging a scene, ToF sensors for LIDAR applications can include circuits that time stamp and/or count incident photons as reflected from a target. Some ToF pixel approaches may use digital or analog circuits to count the detection of photons and the arrival times of photons, also referred to as time-stamping.

Data rates can be compressed by histogramming timestamps. Some systems may perform in-pixel histogramming of incoming photons using a clock driven architecture and a limited memory block, which may provide a significant increase in histogramming capacity. However, since memory size is limited and typically cannot cover the desired distance range at once, such systems may operate in “strobing” mode. “Strobing” may refer to the generation of detector control signals (also referred to herein as strobe signals or “strobes”) to control the timing and/or duration of activation (also referred to herein as detection windows or strobe windows) of one or more detectors of the LIDAR system, such that photon detection and histogramming is performed sequentially over respective time windows, each corresponding to a respective distance subrange, so as to collectively define the full distance range. The histogram bins may indicate respective subranges of photon arrival times, and may also referred to herein as time bins. In other words, partial histograms are acquired for subranges or “time slices” corresponding to the distance range and then amalgamated into one full-range histogram. Thousands of time bins (each corresponding to respective photon arrival times) may typically be used to form a histogram sufficient to cover the typical time range of a LIDAR system (e.g., microseconds) with the typical time to digital converter (TDC) resolution (e.g., 50-100 ps).

Due to the strobing nature of such systems, the average power of the emitter elements may be relatively high, as the emitter elements may be operated by a factor equivalent to the number of strobes used by the system. Strobing can also restrict the number of laser cycles used due to frame rate constraints, and can introduce image artifacts due to motion or changes in background level estimates (i.e., due to photon detection from sources other than the emitter elements) when combining partial histograms from sequentially acquired time slices.

### SUMMARY

According to some embodiments, a Light Detection and Ranging (LIDAR) detector circuit includes a non-transitory memory device comprising a first memory and a second memory, and at least one control circuit. The at least one control circuit is configured to execute first memory storage operations to store data indicated by detection signals received from one or more photodetector elements in the first memory during a time between pulses of an emitter signal output from a LIDAR emitter element, and is configured to execute second memory storage operations to include previous data indicated by previous detection signals received from the one or more photodetector elements, which was stored in the first memory, in respective memory bins of the second memory. The first and second memory storage operations are executed at least partially concurrently.

In some embodiments, execution of the second memory storage operations may include at least one of: executing the second memory storage operations during execution of the first memory storage operations: performing read, modify, and write operations to include the previous data in the respective memory bins responsive to a common precharge operation: or, where the second memory is partitioned into respective memory banks, addressing the respective memory bins of each of the respective memory banks in parallel.

In some embodiments, the first memory comprises a pipeline memory, the second memory comprises a main memory, and the non-transitory memory device further comprises a temporary memory. The second memory storage operations comprise retrieving the previous data from the temporary memory and integrating the previous data in the respective memory bins of the main memory.

In some embodiments, at least one control circuit is further configured to execute third memory storage operations to transfer the previous data from the pipeline memory to the temporary memory before execution of the first memory storage operations.

In some embodiments, the at least one control circuit is further configured to execute third memory storage operations to transfer the data from the pipeline memory to the temporary memory during the integrating of the previous data in the respective memory bins of the main memory.

In some embodiments, the pipeline memory is configured to store the data with a bit length corresponding to a number of the respective memory banks, and the temporary memory is configured to store at least a same number of bits as the pipeline memory.

In some embodiments, the pipeline memory comprises a shift register, and a bit width of the shift register is less than or equal to a number of the one or more photodetector elements.

In some embodiments, the at least one control circuit is configured to execute the first memory storage operations in series, and to execute the third memory storage operations in parallel.

In some embodiments, the at least one control circuit is configured to execute the first memory storage operations responsive to a first clock signal, and to execute the third memory storage operations responsive to a second clock signal that is based on the first clock signal and a bit length of the pipeline memory or a number of the respective memory banks.

In some embodiments, the first memory storage operations comprise sampling the data from the detection signals at a predetermined sampling rate and writing the data to respective bins of the pipeline memory.

In some embodiments, the predetermined sampling rate corresponds to a period of a clock signal, and the second memory storage operations are independent of the period of the clock signal.

In some embodiments, the second memory storage operations are performed over two or more periods of the clock signal.

In some embodiments, the at least one control circuit comprises respective logic circuits configured to execute the read, modify, and write operations for the respective memory banks in parallel, responsive to the common precharge operation.

In some embodiments, the respective memory bins of the second memory comprise histogram data for an imaging distance subrange comprising up to an entirety of a distance range corresponding to the time between the pulses of the emitter signal.

According to some embodiments, a Light Detection and Ranging (LIDAR) detector circuit includes one or more photodetector elements defining a LIDAR detector pixel, a pipeline memory device, a main memory device, and at least one control circuit. The at least one control circuit is configured to execute first and second memory storage operations to store current and previous data indicated by detection signals received from the LIDAR detector pixel in the pipeline and main memory devices, respectively. The at least one control circuit is configured to execute the first memory storage operations responsive to a first clock signal, and is configured to execute the second memory storage operations independent of a period of the first clock signal.

In some embodiments, the LIDAR detector circuit further includes a temporary memory device, and the second memory storage operations comprise retrieving the previous data from the temporary memory device and integrating the previous data in the main memory device.

In some embodiments, the at least one control circuit is configured to execute the second memory storage operations at least partially concurrently with execution of the first memory storage operations.

In some embodiments, the main memory is partitioned into respective memory banks, and execution of the second memory storage operations comprises addressing respective memory bins of each of the respective memory banks in parallel.

In some embodiments, execution of the second memory storage operations comprises performing read, modify, and write operations to include the previous data in respective memory bins of the main memory responsive to a common precharge operation.

In some embodiments, the at least one control circuit comprises respective logic circuits configured to perform the read, modify, and write operations for the respective memory banks in parallel, responsive to the common precharge operation.

In some embodiments, the at least one control circuit is further configured to execute third memory storage operations to transfer the previous data from the pipeline memory device to the temporary memory device before execution of the first memory storage operations.

In some embodiments, the at least one control circuit is further configured to execute third memory storage operations to transfer the current data from the pipeline memory to the temporary memory device during execution of the second memory storage operations.

In some embodiments, the at least one control circuit is configured to execute the third memory storage operations responsive to a second clock signal that is based on the first clock signal and a number of respective memory banks of the main memory.

In some embodiments, the first memory storage operations comprise sampling the data from the detection signals at a predetermined sampling rate that corresponds to the period of the first clock signal and writing the data to respective bins of the pipeline memory device.

In some embodiments, the second memory storage operations are performed over two or more periods of the first clock signal during a time between pulses of an emitter signal output from a LIDAR emitter element.

According to some embodiments, a method of operating a Light Detection and Ranging (LIDAR) detector circuit includes performing, by at least one control circuit coupled to a non-transitory memory device comprising a first memory and a second memory, operations comprising: executing first memory storage operations to store, in the first memory, data indicated by detection signals received from one or more photodetector elements during a time between pulses of an emitter signal output from a LIDAR emitter element: and, at least partially concurrently with executing the first memory storage operations, executing second memory storage operations to include, in respective memory bins of the second memory, previous data indicated by previous detection signals received from the one or more photodetector elements, which was stored in the first memory.

In some embodiments, executing the second memory storage operations comprises at least one of: executing the second memory storage operations during the execution of the first memory storage operations; performing read, modify, and write operations to include the previous data in the respective memory bins responsive to a common precharge operation; or
where the second memory is partitioned into respective memory banks, addressing the respective memory bins of each of the respective memory banks in parallel.

In some embodiments, the first memory comprises a pipeline memory, the second memory comprises a main memory, and the non-transitory memory device further comprises a temporary memory. Executing the second memory storage operations further comprises retrieving the previous data from the temporary memory and integrating the previous data in the respective memory bins of the main memory.

In some embodiments, the operations further comprise executing third memory storage operations to transfer the previous data from the pipeline memory to the temporary memory before execution of the first memory storage operations.

In some embodiments, the operations further comprise executing third memory storage operations to transfer the data from the pipeline memory to the temporary memory during the integrating of the previous data in the respective memory bins of the main memory.

In some embodiments, executing the first memory storage operations is responsive to a first clock signal, and executing the second memory storage operations is independent of a period of the first clock signal.

In some embodiments, executing the third memory storage operations is responsive to a second clock signal that is based on the first clock signal and a bit length of the pipeline memory or a number of the respective memory banks.

In some embodiments, the one or more photodetector elements comprise single-photon avalanche detectors (SPADs), and wherein the data and/or the previous data comprises photon counts indicated by the detection signals corresponding to portions of the imaging distance subrange.

In some embodiments, the pipeline memory, the main memory, and/or the temporary memory comprises a static random access memory (SRAM) or a dynamic random access memory (DRAM).

In some embodiments, the LIDAR system is configured to be coupled to an autonomous vehicle such that the LIDAR emitter element and the one or more photodetector elements are oriented relative to an intended direction of travel of the autonomous vehicle.

Other devices, apparatus, and/or methods according to some embodiments will become apparent to one with skill in the art upon review of the following drawings and detailed description. It is intended that all such additional embodiments, in addition to any and all combinations of the above embodiments, be included within this description, be within the scope of the invention, and be protected by the accompanying claims.

### BRIEF DESCRIPTION OF THE DRAWINGS

FIG. 1 is a schematic block diagram illustrating an example lidar system that may utilize memory storage operations in accordance with embodiments of the present disclosure.

FIG. 2 is a schematic block diagram illustrating example components of a ToF measurement system or circuit in a lidar application in accordance with some embodiments of the present disclosure.

FIG. 3A is a schematic block diagram illustrating an example configuration of a memory circuit implementing a memory pixel in accordance with some embodiments of the present disclosure.

FIG. 3B is a schematic block diagram illustrating the parallel pixel arrangement and other elements of the memory pixel of FIG. 3A in greater detail.

FIG. 4 is an example timing diagram illustrating sampling and integration operations for a parallel pixel arrangement with shared PRMW logic in accordance with some embodiments of the present disclosure.

FIG. 5A is a schematic block diagram illustrating an example configuration of a memory circuit implementing a memory pixel in accordance with further embodiments of the present disclosure.

FIG. 5B is a schematic block diagram illustrating the parallel pixel arrangement and other elements of the memory pixel of FIG. 5A in greater detail.

FIG. 6 is an example timing diagram illustrating sampling and integration operations for a parallel pixel arrangement with parallel PRMW logic in accordance with further embodiments of the present disclosure.

FIG. 7 is a schematic block diagram illustrating an example of a memory circuit configured for single-strobe operation.

FIG. 8 is a schematic block diagram illustrating operation of the memory circuit of FIG. 7.

### DETAILED DESCRIPTION OF EMBODIMENTS

In the following detailed description, numerous specific details are set forth to provide a thorough understanding of embodiments of the present disclosure. However, it will be understood by those skilled in the art that the present disclosure may be practiced without these specific details. In some instances, well-known methods, procedures, components, and circuits have not been described in detail so as not to obscure the present disclosure. It is intended that all embodiments disclosed herein can be implemented separately or combined in any way and/or combination. Aspects described with respect to one embodiment may be incorporated in different embodiments although not specifically described relative thereto. That is, all embodiments and/or features of any embodiments can be combined in any way and/or combination.

Embodiments of the present disclosure are described herein with reference to lidar applications and systems. A lidar system may include an array of emitter elements (referred to herein as emitters) and an array of detector elements (referred to herein as detectors), or a system having a single emitter and an array of detectors, or a system having an array of emitters and a single detector. As described herein, one or more emitters may define an emitter unit, and one or more detectors may define a detector pixel. A flash lidar system may acquire images by emitting light from an array of emitters, or a subset of the array, for short durations (pulses) over a field of view (FoV) or scene, and detecting the echo signals reflected from one or more targets in the FoV at one or more detectors. A non-flash or scanning lidar system may generate image frames by scanning light emission (e.g., continuously) over a field of view or scene, for example, using a point scan or line scan to emit the necessary power per point and sequentially scan to reconstruct the full FoV. A detection window or strobe window may refer to the respective durations of activation and deactivation of one or more detectors (e.g., responsive to respective detector time gates or strobe signals from a control circuit) over a temporal period or time between pulses of the emitter(s) (which may likewise be responsive to respective emitter control signals from a control circuit).

Embodiments of the present disclosure may arise from realization that next-generation dToF sensors may ideally operate with strobe windows of longer time durations and corresponding farther distance subranges (e.g., with each strobe window corresponding to a 200 meter (m) distance subrange) or even as a single strobe system whereby the full distance range (e.g., 400 m) is acquired at once, also referred to as single or full range acquisition. Longer strobe windows may be used to gather more light in a laser cycle and reduce the power required of the emitters, which can reduce device costs, area requirements, and/or increase power efficiency.

To implement longer strobe windows, a detector pixel with a large memory capacity for histogramming may be needed. A memory device, such as Dynamic Random Access Memory (DRAM) or Static Random Access Memory (SRAM), may be used for main memory storage. Embodiments are primarily described herein with reference to a SRAM-based memory or memory banks by way of example, but may be similarly applied other memory types, such as (but not limited to) DRAM.

However, larger memory capacities may present challenges. For example, the precharge-read-modify-write (PRMW) logic incorporated in some SRAM configurations may be large and difficult to incorporate in smaller pixel due to layout/space limitations, particularly as speed and storage requirements increase. The precharge-read-modify-write (PRMW) memory storage operations (which can integrate detection events indicating detection of photons into data that is stored in memory bins) can also impose restrictions on the amount of time required to store the detection events in a memory device, also referred to as the integration time, T_{integrate}.

In a PRMW operation, the current contents of a given memory bin 0 to n−1 is read (i.e., in a read operation), incremented or refreshed (responsive to the presence or absence of detection events, respectively: i.e., in a modify operation), and written back (i.e., in a write operation) to the respective memory bin. The time available to perform a memory update to include (or “integrate”) a detection event into histogram data stored in the memory device may be restricted based on bin time (as shown in the example of FIG. 8), and may be further constrained by times associated with bit-line settling, memory arithmetic logic unit (ALU) settling, and/or ability to drive back the bit lines and the memory to a new, updated value. That is, the larger the memory capacity, the larger the bit-line parasitics, and the more difficult it may be to successfully perform a PRMW operation within the allocated time. Conversely, such restrictions imposed by the time required for the PRMW operations can impact the clock driven system sampling speed, which in turn impacts the temporal resolution of the dToF system (i.e., the amount of time represented by each memory bin, also referred to as bin size, bin time, or bin width).

Larger memory capacities can also impose addressing challenges within the pixel. Area and power requirements for the circuit logic responsible for addressing the memory banks corresponding to bins may grow as the number of memory bins increases, which can compete with available in-pixel area resources and power budgets, making it difficult to realize a larger memory in-pixel. As used herein, “in-pixel” configurations may refer to configurations where each detector pixel includes or provides outputs to dedicated circuits, such as storage and/or logic circuits (including correlator, counter, and/or time integrator logic), which are not shared with other detector pixels.

Some of the above challenges may be addressed in existing strobe based architectures. Such architectures are described, for example, in U.S. patent application Ser. No. 16/746,218 entitled “Digital Pixels and Operating Methods Thereof”; PCT Application No. US2020/030920 entitled “Event Driven Shared Memory Pixel”: U.S. patent application Ser. No. 17/071,589 entitled “Strobing Flash Lidar with Full Frame Utilization”: U.S. patent application Ser. No. 17/143,570) entitled “Pipelined SRAM Histogram Pixel.”

However, some existing strobe based architectures may have limitations. For example, some systems employing adder circuits for PRMW operations (where the adder circuit adds the already stored count in a histogram bin to the new sampled count and writes back to the bin) may be limited by ALU settling time and SRAM bit-line parasitics for read/write settling, which may limit minimum bin times despite a small number of bins. In some systems employing linear feedback shift register (LFSR)-based PRMW operations, the speed at which the LFSR can operate may be restricted as the memory size increases (e.g., due to increased bit-line parasitics). Systems that share PRMW logic between multiple memory banks (collectively forming a full frame memory) may reduce bit-line parasitics, but PRMW speed may still be directly coupled to the system clock, thereby restricting the sampling frequency (i.e., bin width). Some systems employing pipelined timing (by which sampled photon events are stored in a temporary memory within the strobe window, then added to the main memory (via PRMW operations) outside the strobe window) may be impractical to implement with larger capacity memory arrays, due to the increased capacity requirements for the temporary memory. Also, the pipelining operations utilize deadtime within the laser cycle outside the time of the strobe window: however, a single strobe system may not include such deadtime (as data may be collected over the full period between laser pulses) and therefore an additional time overhead may be needed to add the photon detection events stored in the temporary memory into the main memory block at a slower speed.

Embodiments of the present disclosure are directed to providing a highly-parallel large memory in-pixel. In some embodiments, this may be implemented by splitting or partitioning a large memory block into parallel smaller memory blocks or banks (e.g., by addressing K smaller memory banks of an N-bin×M-bit per bin memory in parallel, reducing addressing circuit requirements), partially pipelining the photon samples (e.g., by storing the K sampled photon detection events in a K-bit shift register), shifting the same number of pipelined samples into a temporary small memory (e.g., by transferring the sampled data into a K-bit register responsive to every K-th clock signal), and performing PRMW memory operations for the photon samples while partially pipelining the next photon samples (to integrate the previously sampled photon detection events into the N×M memory during a same or overlapping portion of the emitter cycle as sampling the next set of photon detection events). The timing of the “partial” pipelining may be used to reduce temporary or buffer memory requirements, for example, using a serial-in, parallel-out operations.

Embodiments of the present disclosure may provide several advantages. For example, the memory splitting or partitioning may reduce bit-line parasitics, which can benefit read/write settling time. Also, the parallel operation of the K memory banks can reduce the number of addresses needed to cycle through all the N memory bins by a factor equivalent to the number K of parallel banks (e.g., N/K), thereby reducing area, operation speed, and power requirements for the address generation circuit. Non-exclusive components, such as the address generator and/or timing control circuits, can be shared between multiple highly parallel pixels to further reduce area and increase power efficiency.

In addition, partial pipelining operations in accordance with embodiments of the present disclosure may use a small pipeline memory and a small temporary storage memory. Write operations into the temporary memory may be very fast and low power in comparison to the typical memory storage operations (e.g., the full PRMW cycle for a SRAM device). The respective bit capacities of the pipeline memory and the temporary storage memory may be equivalent to the number K of parallel memory banks, rather than the total number N of memory bins. The partial pipeline operation can be considered as a serial-in, parallel-out (SIPO) operation.

Accordingly, in embodiments of the present disclosure, the time needed to perform the PRMW memory operations to integrate the sampled photon detection events into the main memory (the integration time, T_{integrate}) may be decoupled from the system sampling rate or clock frequency, which may correspond to the bin width. For example, the more time-consuming memory storage operations for storing and/or integrating the photon counts into a histogram data stored in the main memory (e.g., an N-bin×M-bit per bin SRAM array) may be performed over multiple clock periods or cycles. That is, operations described herein may avoid PRMW operations from imposing limitations on the sampling frequency (which may be based on the global or system clock), thereby allowing for higher sampling rates and finer temporal resolution of the memory bins. Embodiments described herein may be used in conjunction with some single- or multi-strobe based implementations.

Although described primarily herein with reference to SRAM-based memory devices, it will be understood that embodiments of the present disclosure may provide similar benefits using DRAM (dynamic random access memory)-based memory devices or other memory device technologies. For example, DRAM may be even more compact than SRAM, and the memory storage operations described herein can be similarly performed in conjunction with a refresh mechanism for the DRAM memory cells (which is not required for SRAM, which holds state). More generally, embodiments of the present disclosure are not limited to SRAM, DRAM, or any particular memory storage technology, and may be applied to memory devices other than those specifically described herein.

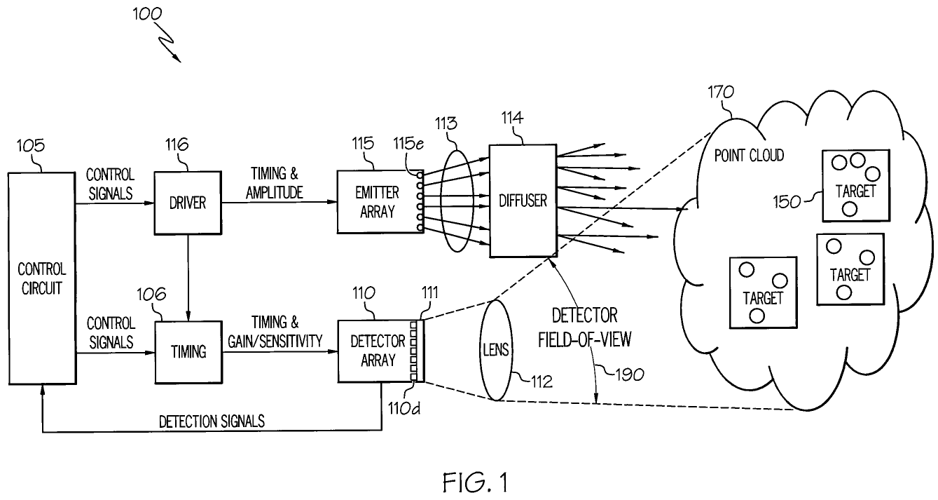

An example of a lidar system or circuit 100 that may utilize partially-pipelined memory storage operations in accordance with embodiments of the present disclosure is shown in FIG. 1. The lidar system 100 includes a control circuit 105, a timing circuit 106, an emitter array 115 including a plurality of emitters 115e, and a detector array 110 including a plurality of detectors 110d. The detectors 110d include time-of-flight sensors (for example, an array of single-photon detectors, such as SPADs). One or more of the emitter elements 115e of the emitter array 115 may define emitter units that respectively emit a radiation pulse or continuous wave signal (for example, through a diffuser or optical filter 114) at a time and frequency controlled by a timing generator or driver circuit 116. In particular embodiments, the emitters 115e may be pulsed light sources, such as LEDs or lasers (such as vertical cavity surface emitting lasers (VCSELs)). Radiation is reflected back from a target 150, and is sensed by detector pixels defined by one or more detector elements 110d of the detector array 110. The control circuit 105 implements a pixel processor that measures and/or calculates the time of flight of the illumination pulse over the journey from emitter array 115 to target 150 and back to the detectors 110d of the detector array 110, using direct or indirect ToF measurement techniques.

In some embodiments, an emitter module or circuit 115 may include an array of emitter elements 115e (e.g., VCSELs), a corresponding array of optical elements 113,114 coupled to one or more of the emitter elements (e.g., lens(es) 113 (such as microlenses) and/or diffusers 114), and/or driver electronics 116. The optical elements 113, 114 may be optional, and can be configured to provide a sufficiently low beam divergence of the light output from the emitter elements 115e so as to ensure that fields of illumination of either individual or groups of emitter elements 115e do not significantly overlap, and yet provide a sufficiently large beam divergence of the light output from the emitter elements 115e to provide eye safety to observers.

The driver electronics 116 may each correspond to one or more emitter elements, and may each be operated responsive to timing control signals with reference to a master clock and/or power control signals that control the peak power and/or the repetition rate of the light output by the emitter elements 115e. In some embodiments, each of the emitter elements 115e in the emitter array 115 is connected to and controlled by a respective driver circuit 116. In other embodiments, respective groups of emitter elements 115e in the emitter array 115 (e.g., emitter elements 115e in spatial proximity to each other), may be connected to a same driver circuit 116. The driver circuit or circuitry 116 may include one or more driver transistors configured to control the modulation frequency, timing and amplitude of the optical emission signals that are output from the emitters 115e.

The emission of optical signals from multiple emitters 115e provides a single image frame for the flash LIDAR system 100, but embodiments of the present disclosure may include non-flash or scanning LIDAR systems as well. The maximum optical power output of the emitters 115e may be selected to generate a signal-to-noise ratio of the echo signal from the farthest, least reflective target at the brightest background illumination conditions that can be detected in accordance with embodiments described herein. An optional filter to control the emitted wavelengths of light and diffuser 114 to increase a field of illumination of the emitter array 115 may be included in some embodiments.

Light emission output from one or more of the emitters 115e impinges on and is reflected by one or more targets 150, and the reflected light is detected as an optical signal (also referred to herein as a return signal, echo signal, or echo) by one or more of the detectors 110d (e.g., via receiver optics 112), converted into an electrical signal representation (referred to herein as a detection signal), and processed (e.g., based on time of flight) to define a 3-D point cloud representation 170 of the field of view 190. Operations of lidar systems in accordance with embodiments of the present disclosure as described herein may be performed by one or more processors or controllers, such as the control circuit 105 of FIG. 1.

In some embodiments, a receiver/detector module or circuit 110 includes an array of detector pixels (with each detector pixel including one or more detectors 110d, e.g., SPADs), receiver optics 112 (e.g., one or more lenses to collect light over the FoV 190), and receiver electronics (including timing circuit 106) that are configured to power, enable, and disable all or parts of the detector array 110 and to provide timing signals thereto. The detector pixels can be activated or deactivated with at least nanosecond precision, and may be individually addressable, addressable by group, and/or globally addressable. The receiver optics 112 may include a macro lens that is configured to collect light from the largest FoV that can be imaged by the lidar system, microlenses to improve the collection efficiency of the detecting pixels, and/or anti-reflective coating to reduce or prevent detection of stray light. In some embodiments, a spectral filter 111 may be provided to pass or allow passage of ‘signal’ light (i.e., light of wavelengths corresponding to those of the optical signals output from the emitters) but substantially reject or prevent passage of non-signal light (i.e., light of wavelengths different than the optical signals output from the emitters).

The detectors 110d of the detector array 110 are connected to the timing circuit 106. The timing circuit 106 may be phase-locked to the driver circuitry 116 of the emitter array 115. The sensitivity of each of the detectors 110d or of groups of detectors may be controlled. For example, when the detector elements include reverse-biased photodiodes, avalanche photodiodes (APD), PIN diodes, and/or Geiger-mode Avalanche Diodes (SPADs), the reverse bias may be adjusted, whereby, the higher the overbias, the higher the sensitivity.

In some embodiments, a control circuit 105, such as a microcontroller or microprocessor, provides different emitter control signals to the driver circuitry 116 of different emitters 115e and/or provides different detector control signals (e.g., strobe signals) to the timing circuitry 106 of different detectors 110d to enable/disable the different detectors 110d so as to detect the echo signal from the target 150. The control circuit 105 may also control memory storage operations for storing data indicated by the detection signals in a non-transitory memory or memory array that is included therein or is distinct therefrom.

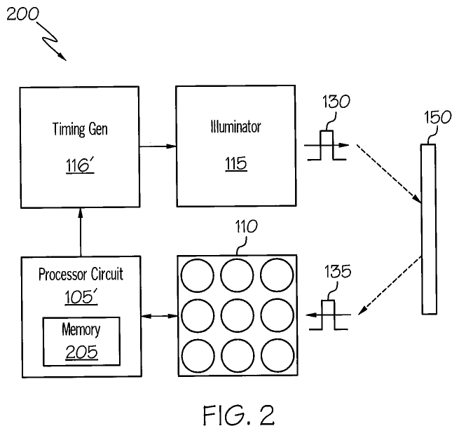

FIG. 2 further illustrates components of a ToF measurement system or circuit 200 in a LIDAR application in accordance with some embodiments described herein. The circuit 200 may include a processor circuit 105′ (such as a digital signal processor (DSP) or other control circuit 105), a timing generator 116′ which controls timing of the illumination source (illustrated by way of example with reference to a laser emitter array 115), and an array of single-photon detectors (illustrated by way of example with reference to a single-photon detector array 110). The processor circuit 105′ may also include a sequencer circuit that is configured to coordinate operation of the emitters 115e and detectors 110d.

The processor circuit 105′ and the timing generator 116′ may implement some of the operations of the control circuit 105 and the driver circuit 116 of FIG. 1. The laser emitter array 115 emits a laser pulse 130 at a time controlled by the timing generator 116′. Light 135 from the laser pulse 130 is reflected back from a target (illustrated by way of example as object 150), and is sensed by single-photon detector array 110. The processor circuit 105′ implements a pixel processor that measures the ToF of the laser pulse 130 and its reflected signal 135 over the journey from emitter array 115 to object 150 and back to the single-photon detector array 110.

The processor circuit 105′ may provide analog and/or digital implementations of logic circuits that provide the necessary timing signals (such as quenching and gating or strobe signals) to control operation of the single-photon detectors of the array 110 and process the detection signals output therefrom. For example, the single-photon detectors of the array 110 may generate detection signals in response to incident photons only during the gating intervals or strobe windows that are defined by the strobe signals. Photons that are incident outside the strobe windows have no effect on the outputs of the single photon detectors. More generally, the processor circuit 105′ may include one or more circuits that are configured to generate the respective detector control signals that control the timing and/or durations of activation of the detectors 110d, and/or to generate respective emitter control signals that control the output of optical signals from the emitters 115e.

Detection events may be identified by the processor circuit 105′ based on one or more photon counts indicated by the detection signals output from the detector array 110, which may be stored in a non-transitory memory 205. In some embodiments, the processor circuit 105′ may include a correlation circuit or correlator that identifies detection events based on photon counts (referred to herein as correlated photon counts) from two or more detectors within a predefined window of time relative to one another, referred to herein as a correlation window or correlation time, where the detection signals indicate arrival times of incident photons within the correlation window. As photons corresponding to the optical signals output from the emitter array 115 (also referred to as signal photons) may arrive relatively close in time as compared to photons corresponding to ambient light (also referred to as background photons), the correlator is configured to distinguish signal photons based on respective times of arrival within the correlation time relative to one another. Such correlators are described, for example, in U.S. Patent Application Publication No. 2019/0250257 entitled “Methods and Systems for High-Resolution Long Range Flash Lidar,” which is incorporated by reference herein.

The processor circuit 105′ may be small enough to allow for three-dimensionally stacked implementations, e.g., with the array 110 “stacked” on top of processor circuit 105′ (and other related circuits) that is sized to fit within an area or footprint of the array 110. For example, some embodiments may implement the detector array 110 on a first substrate, and transistor arrays of the circuits 105′ on a second substrate, with the first and second substrates/wafers bonded in a stacked arrangement, as described for example in U.S. patent application Ser. No. 16/668,271 entitled “High Quantum Efficiency Geiger-Mode Avalanche Diodes Including High Sensitivity Photon Mixing Structures and Arrays Thereof,” filed Oct. 30, 2019, the disclosure of which is incorporated by reference herein.

The pixel processor implemented by the processor circuit 105′ is configured to calculate an estimate of the average ToF aggregated over thousands of laser pulses 130 and photon returns in reflected light 135. The processor circuit 105′ may be configured to count incident photons in the reflected light 135 to identify detection events (e.g., based on one or more SPADs 110 that have been “triggered”) over a laser cycle (or portion thereof).

The timings and durations of the detection windows may be controlled by a strobe signal (Strobe #i or Strobe<i>) as described herein. Many repetitions of Strobe #i are aggregated (e.g., in the pixel) to define a sub-frame for Strobe #i, with subframes i=1 to n defining an image frame. Each sub-frame for Strobe #i may correspond to a respective distance sub-range of the overall imaging distance range. In a single-strobe system, each sub-frame for Strobe #i may correspond to the overall imaging distance range. The time between emitter pulses (which defines a laser cycle, or more generally emitter pulse frequency) may be selected to define or may otherwise correspond to the desired overall imaging distance range for the LIDAR system 100.

In some embodiments, a detector pixel may include circuits that implement a memory array (e.g., memory 205) and a memory controller (e.g., control circuit 105/processor 105″), such as an SRAM and PRMW controller, collectively referred to herein as a memory circuit.

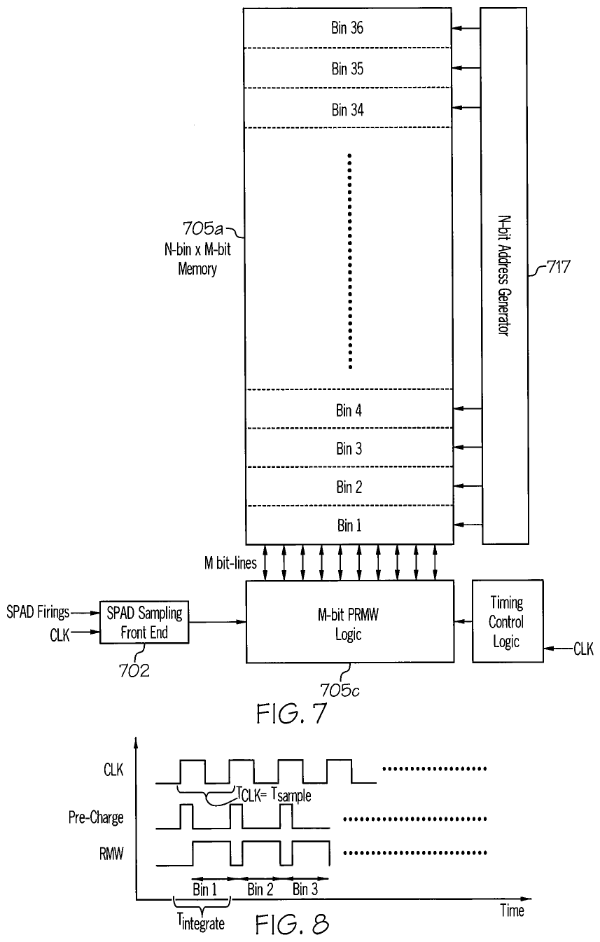

FIG. 7 illustrates an example of a memory circuit configured for single-strobe operation. In the example of FIG. 7, a large N×M memory in-pixel arrangement includes 36-bins of 10-bits, addressable as a single memory block or bank 705a, where N is the number of bins, and M is the number of bits per bin. As shown in FIG. 7, the memory bank 705a requires an address generator 717 of N bits and a PRMW logic (which may be binary ALU based, LFSR based, or otherwise) memory controller 705c of M bits, corresponding to the number of bit lines M in the memory block 705a.

FIG. 8 illustrates operation of the PRMW logic of FIG. 7, where the four memory operations of precharge, read, modify, and write are performed within a single system clock cycle duration (i.e., within the period T_{CLK} of the clock signal CLK). More particularly, the SPAD events or firings are sampled by sampler circuit 702 responsive to the system clock CLK (i.e., the sampling period Tₛₐₘₚₗₑ is controlled by the clock signal CLK) and fed into the corresponding histogram memory bin of the N×M memory array 705a sequentially in time by the M-bit PRMW logic circuit 705c. That is, each photon detection event (e.g., SPAD event) is sampled and directly stored as histogram data in the main memory 705a, requiring each PRMW memory operation to be completed within each sample cycle Tₛₐₘₚₗₑ or clock period T_{CLK}. The PRMW operations in FIGS. 7 and 8 may be limited by the parasitics of the bit-lines and the settling of the PRMW logic, thereby limiting the system sampling clock speed (and thus, the bin width or temporal resolution). Also, the number of addresses needed the example of FIGS. 7 and 8 is equal to the number of bins N; therefore, the size of the required address generator circuit 717 may increase with memory capacity of the memory array. Moreover, in the example of FIGS. 7 and 8, the speed at which the address generator 717 is operated is equivalent to or otherwise dictated by the sampling clock signal CLK, where such increased speed may result in increased power consumption.

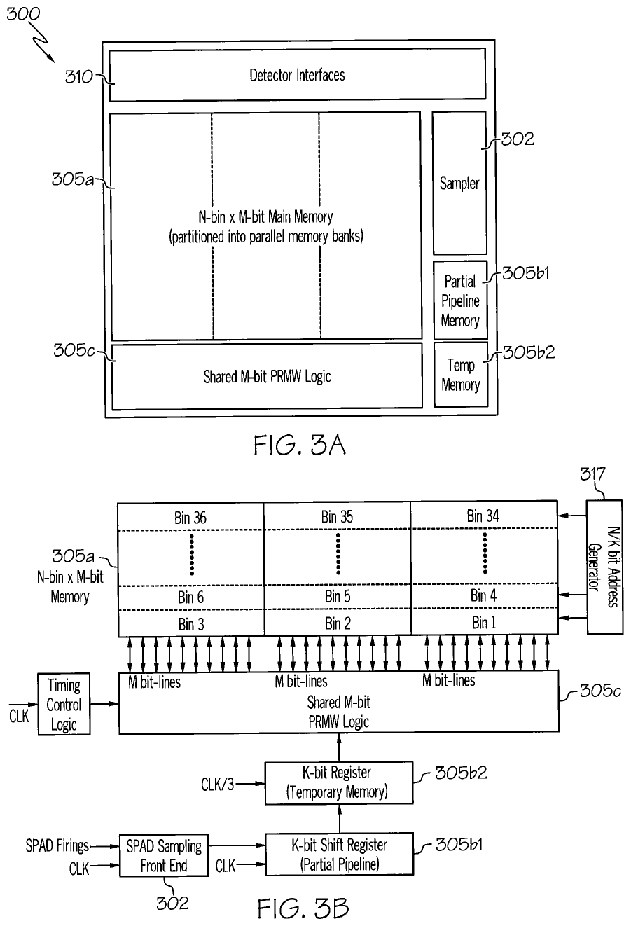

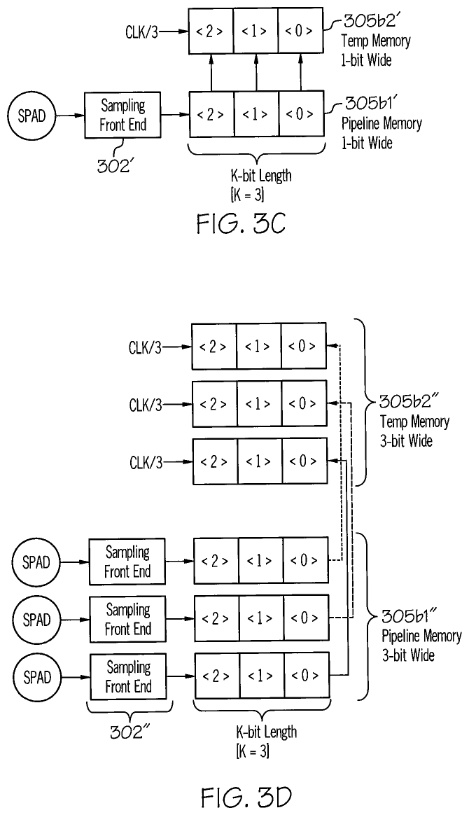

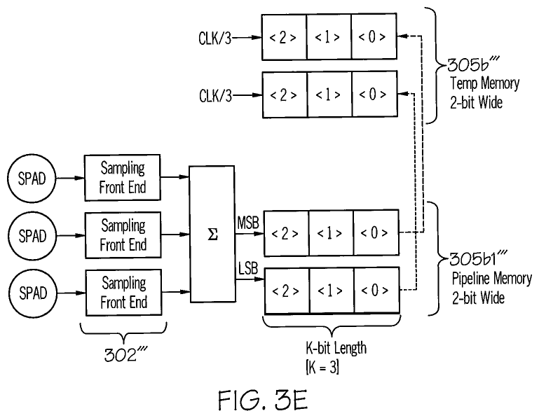

FIG. 3A illustrates an example configuration of a memory circuit implementing a memory pixel 300 (e.g., an SRAM pixel or DRAM pixel) in accordance with some embodiments of the present disclosure. In some embodiments, the memory pixel 300 of FIG. 3A may represent a lower or bottom tier of a pixel layout, for example, on which one or more detector pixels may be stacked to define a three-dimensionally stacked implementation. Multiple memory pixels 300 of FIG. 3A may thus be sized to fit within the area or footprint of the detector array 110.

The memory pixel 300 of FIG. 3A includes a photodetector interface circuit 310 configured to receive detection signals from one or more photodetectors (e.g., SPADs), a sampler circuit 302 configured to sample the detection signals output from the photodetectors, a main memory device 305a (also referred to herein as a main memory) configured to store histogram data (illustrated as a N×M main memory device, where N refers to the number of memory bins and M refers to the bits per bin), and a memory controller circuit 305c (illustrated as M-bit PRMW logic circuit, corresponding to the number of bit lines M in the memory device 305a) that is configured to manage operations of the interface circuit 310, the sampler circuit 302, and the main memory device 305a to store and integrate data indicated by the detection signals output from the photodetectors into the histogram data. Timing control and address generator circuits are not shown in FIG. 3A for ease of illustration, and as noted above, can be shared between multiple memory pixels 300.

In some embodiments, to address the number of addresses needed and bit-line parasitics, the memory 305a can be split into a number K of parallel memory blocks or memory banks. Embodiments of the present disclosure are described herein with reference to examples where K=3, but it will be understood that K may be any number of parallel memory banks (i.e., 2 or more). The number of parallel memory banks K may also be referred to as the parallelism factor.

FIG. 3A illustrates a parallel pixel arrangement in accordance with some embodiments of the present disclosure, where the M-bit PRMW logic circuit 305c is shared by the K memory banks of the main memory 305a. That is, the three parallel memory blocks of the memory 305a are connected to a shared PRMW logic circuit 305c. FIG. 3B shows the parallel pixel arrangement and other elements of the memory pixel 300 in greater detail.

In addition, as shown in FIGS. 3A-3B, the memory pixel further includes additional memory devices, implemented in this example by a pipeline memory device 305b1 (also referred to herein as a partial pipeline memory), and a temporary memory device 305b2 (also referred to herein as a temporary memory). In this example, the partial pipeline memory 305b1 functions as a shift register, while the temporary memory 305b2 functions as a temporary storage register. Both the partial pipeline memory 305b1 and the temporary memory 305b2 are of a size or capacity corresponding to the number of memory banks K (i.e., K-bits), which may be small compared to number of bits N×M in the overall histogram memory 305a. In this example, the number of memory bins N=36, the number of bits per bin M=10, and the N×M main memory is partitioned or split into K=3 banks of N/K=12 bins per bank, with an address generator 317 of N/K bits.

FIGS. 3C, 3D, and 3E illustrate example implementations of the partial pipeline memory device 305b1, 305b1″, 305b1″” (collectively 305b1) and the temporary memory device 305b2, 305b2″, 305b2″ (collectively 305b2) for a single detector input and sampling circuit 302′, for three detector inputs and sampling circuit 302″, and for three detector inputs and sampling circuit 302″ with summation, respectively. As shown in FIGS. 3C, 3D, and 3E, the bit length of the partial pipeline memory device 305b1 and the temporary memory device 305b2 may be equal to the number of memory banks K, while the bit width of the partial pipeline memory device 305b1 and the temporary memory device 305b2 may be less than or equal to the number of detector inputs. More generally, the storage capacities of the partial pipeline 305b1 and temporary memories 305b2 (defined by bit length and bit width) may be configured based on the parallelism factor and the number of detector inputs.

The memory pixel 300 is configured to store data indicating K sampled photon detection events (for example, samples corresponding to bins 1, 2 and 3) in the partial pipeline memory 305b1, which are then transferred from the partial pipeline memory 305b1 to the temporary memory 305b2 responsive to every Kth clock signal (CLK/3 in this example) before the next K photon detection events (corresponding to bins 4, 5 and 6) are captured. While these next K photon detection events are being sampled (i.e., during or at least partially concurrently with sampling and storing the data for the sampled detection events), PRMW operations can be performed to integrate the initial data for the K photon detection events (which are stored in the temporary memory 305b2) into the main memory 305a, with a cumulative PRMW operation time of K CLK cycles available to complete the integration operation. That is, the partial pipelining operations in accordance with embodiments of the present disclosure can allow integration memory storage operations to be performed at least partially concurrently with (e.g., at least partly overlapping in time with) subsequent sampling memory storage operations (in some embodiments in combination with a shared precharge operation), which can provide longer integration intervals within a laser repetition period.

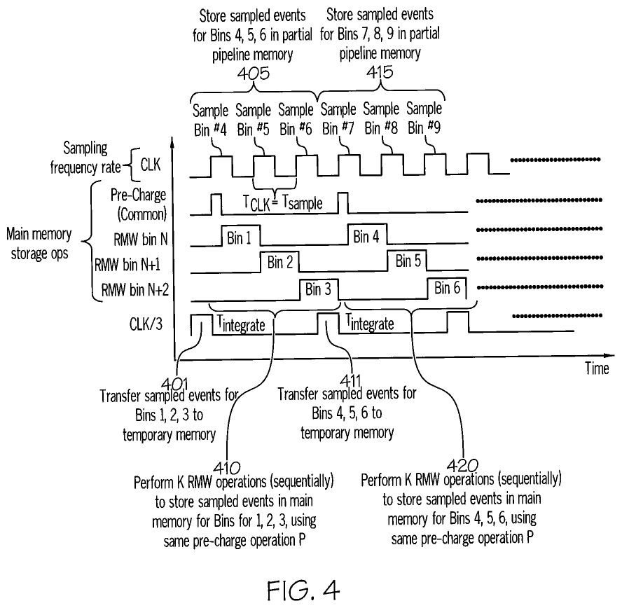

An example timing diagram illustrating sampling and integration memory storage operations for a parallel pixel with shared PRMW logic circuit 305c is shown in FIG. 4. As shown in FIG. 4, sampling memory storage operations are executed by sampling the detection signals output from the SPADs at a predetermined sampling rate (e.g., a sampling period Tₛₐₘₚₗₑ, responsive to the period T_{CLK} of the clock signal CLK), and the photon counts indicated by the SPAD events are sequentially or serially written to respective bins of the pipeline memory 305b1 (shown at 405 as storing the data indicated by detection events into bins 4, 5, and 6).

Still referring to FIG. 4, integration memory storage operations (shown at 410) are sequentially executed for previously-sampled data (in this example, data sampled for previous detection events for bins 1, 2, and 3, shown at 401) at a time that may be least partially concurrent or overlapping with the execution of the sampling memory storage operations (for bins 4, 5, and 6, shown at 405). That is, the data previously stored in temporary memory 305b2 for bins 1, 2, and 3 (shown at 401) are read and summed with histogram data stored in the main memory 305a (shown at 410) to integrate the data for bins 1, 2, and 3 with the stored histogram data, but over an integration time T_{integrate} that is not tied to the clock signal CLK (i.e., is independent of a single period T_{CLK} of the clock signal CLK), and overlaps with the storing the data sampled for current detection events in the partial pipeline memory 305b1 (for bins 4, 5, and 6, shown at 405). In the example of FIG. 4, the available integration time T_{integrate} is increased to K cycles of the clock signal CLK, corresponding to the bit capacity of the pipeline memory 305b1. That is, the integration memory storage operations may be performed over two or more cycles or periods of the clock signal CLK, increasing the available integration time T_{integrate} in comparison to some conventional methods.

In addition, as the main memory 305a is partitioned or split into K memory blocks or banks, K bins can be addressed in parallel, which may reduce addressing circuit requirements, and may reduce the impact of bit line parasitics on the temporal resolution. Also, a single or common precharge operation P can be used, responsive to which bins 1, 2 and 3 are multiplexed (e.g., sequentially) into the PRMW logic 305c in order to perform the K read-write-modify (RMW) operations during or concurrently with the sampling operations for bins 4, 5, and 6 (e.g., such that the RMW operations are partially or entirely executed within the time of execution of the sampling operations). The use of the common precharge operation P can reduce the time required to perform the K RMW operations (i.e., the integration memory operations), thereby further increasing the available integration time T_{integrate}.

In other words, in comparison to an architecture as described in FIGS. 7 and 8 where a PRMW operation is completed within each cycle or period T_{CLK} of the clock signal CLK, the time available for RMW or integration may be effectively extended (due to the independence of the integration memory operations with respect to the clock signal CLK, and/or the reduced number of precharge operations P needed), while the memory split into K banks may reduce bit-line parasitics (thereby aiding in settling time requirements).

Referring again to FIG. 4, after the sampling memory operations (shown at 405), the sampled data are transferred to the temporary memory 305b2 (shown at 411) for integration (shown at 420) during the sampling of the next set of data (e.g., for the next three bins 7, 8, and 9, shown at 415), responsive to every K-th clock cycle (e.g., CLK/3). In particular, the data stored in the bins of the temporary memory 305b2 (for bins 4, 5, and 6, shown at 411) are similarly read and summed with histogram data stored in the main memory 305a (shown at 420) to integrate the data for bins 4, 5, and 6 with the stored histogram data, but over an integration time T_{integrate} that is independent of a single period T_{CLK} of the clock signal CLK (e.g., performed over two or more periods T_{CLK} of the clock signal CLK), and overlaps with the storing the data sampled for current detection events in the partial pipeline memory 305b1 (for bins 7, 8, and 9, shown at 415).

The histogram data stored in the main memory 305a may be readout (e.g., by a readout circuit) at predetermined times, for example, at the end of each frame, or at the end of each subframe corresponding to a respective distance subrange (e.g., 0-200 m, 200-400 m, etc.) of the overall imaging distance range (e.g., 400 m) of the LIDAR detector. The readout signal indicating the stored histogram data for the distance subrange may be used to calculate an estimated time of arrival of photons incident on the photodetector elements. In some embodiments, the readout signal may be output responsive to a read signal that is sequentially applied to respective rows (or columns) of the main memory. That is, the readout operations may be performed as a “rolling” readout responsive to exposure of a burst of laser cycles (and the detection signals resulting therefrom).

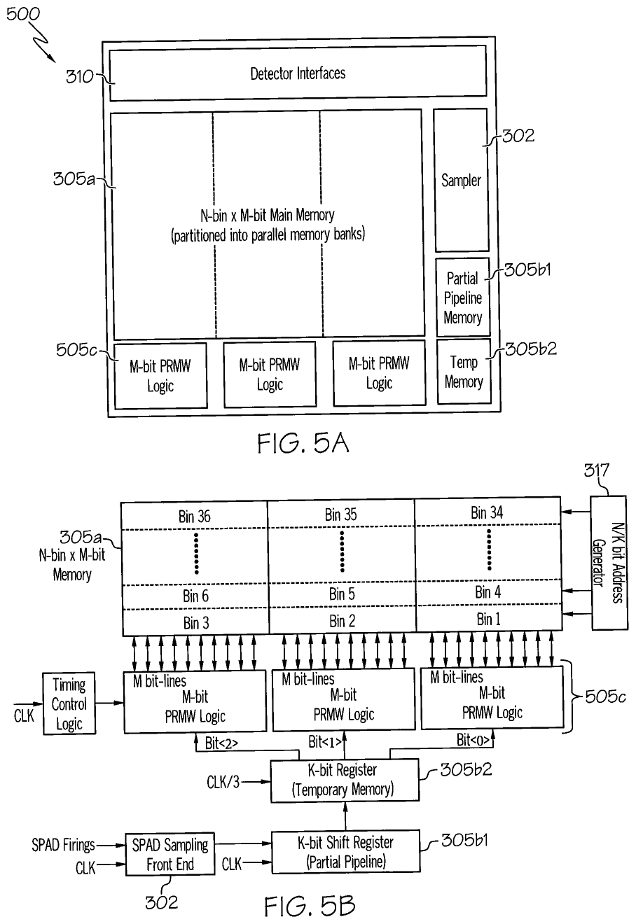

Sharing the PRMW hardware 305c in accordance with embodiments of the present disclosure can reduce the overhead (e.g., the logic circuits used for processing operations described herein) per detector pixel. In some embodiments, a parallel pixel architecture may be used with dedicated PRMW logic circuits 505c per memory split or partition, as shown in FIGS. 5A and 5B, which may further increase the available integration time T_{integrate}.

In particular, FIG. 5A illustrates a parallel pixel arrangement in accordance with some embodiments of the present disclosure, using multiple memory controller circuits (shown as K parallel M-bit PRMW logic circuits 505c, one per memory bank K). FIG. 5B shows the parallel pixel arrangement and other elements of the memory pixel 500 in greater detail. In this configuration, the PRMW operations for the previously stored K samples can be performed in parallel by the respective PRMW logic circuits 505c, while the next K samples are partially pipelined. The memory pixel 500 of FIGS. 5A and 5B is otherwise similar to the memory pixel 300 of FIGS. 3A and 3B.

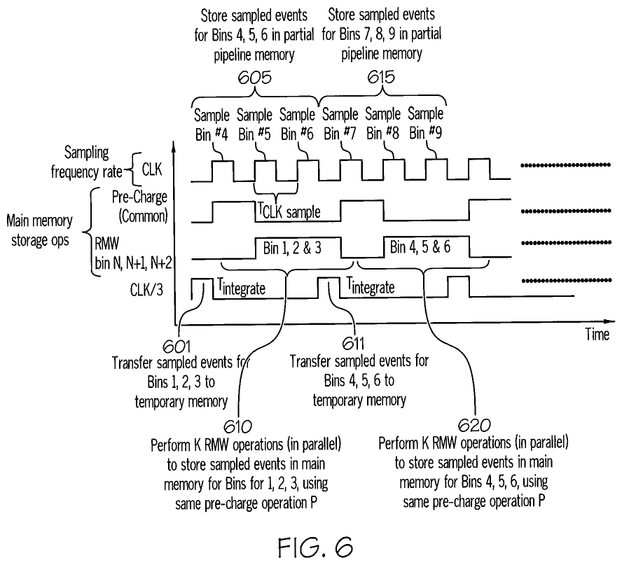

A timing diagram example for parallel pixel with parallel PRMW logic circuits 505c is shown in FIG. 6. Similar to the architecture described in FIG. 4, sampling memory storage operations are executed by sampling the detection signals output from the SPADs at a predetermined sampling rate (e.g., a sampling period Tₛₐₘₚₗₑ, responsive to the period T_{CLK} of the clock signal CLK), and the photon counts indicated by the SPAD events are sequentially or serially written to respective bins of the partial pipeline memory 305b1 (shown at 605 as storing the data indicated by detection events into bins 4, 5, and 6). Integration memory storage operations (shown at 610) are executed for previously-sampled data (data sampled for previous detection events and stored in temporary memory 305b2 for bins 1, 2, and 3, shown at 601) at a time that may be least partially concurrent or overlapping with the execution of the sampling memory storage operations (for bins 4, 5, and 6, shown at 605), but over an integration time T_{integrate} that is independent of a single period T_{CLK} of the clock signal CLK (e.g., performed over two or more periods T_{CLK} of the clock signal CLK). The data stored in the partial pipeline memory 305b1 (for bins 4, 5, and 6, shown at 605) is transferred to the temporary memory 305b2 (shown at 611), and the data stored in temporary memory 305b2 for bins 4, 5, and 6 (shown at 611) are read and summed with histogram data stored in the main memory 305a (shown at 620) to integrate the data for bins 4, 5, and 6 with the stored histogram data, during a time that overlaps with the storing the data sampled for current detection events in the partial pipeline memory 305b1 (for bins 7, 8, and 9, shown at 615) but is independent of a single period T_{CLK} of the clock signal CLK.

Still referring to FIG. 6, a single common precharge operation P (in this example over a duration of one clock cycle) is used for the K RMW operations (shown at 610 and 620). However, the parallel PRMW logic circuits 505c are configured to perform the respective RMW operations (for integrating the data previously stored in the temporary memory 305b2 into bins of the main memory 305a, shown at 610 or 620) in parallel, over a duration of two clock cycles in this example. In other words, two (or more) clock cycles or periods T_{CLK} may be used to complete each RMW operation, which may provide significantly longer integration time T_{integrate} than shown in FIG. 8, and also effectively longer than shown in FIG. 4. This increase or extension in effective PRMW duration may decouple constraints of the integration memory operations from the system clock CLK, while taking advantage of reduced bit-line parasitics due to memory block splitting into K banks. The operations shown in FIG. 6 are otherwise similar to those shown in FIG. 4.

Though the memory devices are described herein with reference to SRAM by way of example, other types of memory devices may be used, both volatile and non-volatile, without deviating from the scope of the present disclosure. For example, the memory used for the SPAD pixels may be dynamic RAM (DRAM), which may be implemented with a refresh mechanism and refresh cycle to avoid loss of data due to leakage. Such refresh mechanisms are further described, for example in U.S. patent application Ser. No. 17/155,871 entitled “DRAM-Based LIDAR Pixel,” the disclosure of which is incorporated by reference herein in its entirety. In some embodiments, the memory may be implemented as high bandwidth memory (HBM). In some embodiments, the memory may be implemented as resistive memory such as phase change RAM (PRAM), magnetic RAM (MRAM), and resistive RAM (RRAM). In addition, multiple variations of each type of memory may be supported. For example, with respect to SRAM, embodiments described herein may be implemented using 6T (six transistor) SRAM, 8T dual-port SRAM, single-ended 6T SRAM, and the like. That is, the memory or memory devices described herein may be any tangible, non-transitory computer-readable storage medium, including electronic, magnetic, optical, electromagnetic, or semiconductor data storage systems, apparatus, or devices.

More generally, embodiments of the present disclosure have been described above with reference to specific implementations by way of example, but it will be understood that embodiments of the present disclosure are not limited to these implementations and may include other implementations that are configured to provide the same or similar effects. For example, different parallelism factors K, multi-SPAD inputs, various memory types (e.g., SRAM and/or DRAM), various memory controllers (e.g., LFSR and/or ALU), and/or various memory configurations (e.g., NMOS and/or PMOS) may be used. Other circuit configurations such as peak detection, switching pixel circuits and SPADs off upon peak detection, blocking circuit operation when no photons are detected, power stepping (in multi-strobe systems), foveated FOV, and/or multi-SPAD control systems, may also be used in conjunction with embodiments of the present disclosure.

Lidar systems and arrays described herein may be applied to ADAS (Advanced Driver Assistance Systems), autonomous vehicles, UAVs (unmanned aerial vehicles), industrial automation, robotics, biometrics, modelling, augmented and virtual reality, 3D mapping, and security. In some embodiments, the emitter elements of the emitter array may be vertical cavity surface emitting lasers (VCSELs). In some embodiments, the emitter array may include a non-native substrate having thousands of discrete emitter elements electrically connected in series and/or parallel thereon, with the driver circuit implemented by driver transistors integrated on the non-native substrate adjacent respective rows and/or columns of the emitter array, as described for example in U.S. Pat. No. 10,962,627 to Burroughs et al., the disclosure of which is incorporated by reference herein.

Various embodiments have been described herein with reference to the accompanying drawings in which example embodiments are shown. These embodiments may, however, be embodied in different forms and should not be construed as limited to the embodiments set forth herein. Rather, these embodiments are provided so that this disclosure is thorough and complete and fully conveys the inventive concept to those skilled in the art. Various modifications to the example embodiments and the generic principles and features described herein will be readily apparent. In the drawings, the sizes and relative sizes of layers and regions are not shown to scale, and in some instances may be exaggerated for clarity.

The example embodiments are mainly described in terms of particular methods and devices provided in particular implementations. However, the methods and devices may operate effectively in other implementations. Phrases such as “example embodiment”, “one embodiment” and “another embodiment” may refer to the same or different embodiments as well as to multiple embodiments. The embodiments will be described with respect to systems and/or devices having certain components. However, the systems and/or devices may include fewer or additional components than those shown, and variations in the arrangement and type of the components may be made without departing from the scope of the inventive concepts.

The example embodiments may be described in the context of particular methods having certain steps or operations. However, the methods and devices may operate effectively for other methods having different and/or additional steps/operations and steps/operations in different orders that are not inconsistent with the example embodiments. Thus, the present inventive concepts are not intended to be limited to the embodiments shown, but are to be accorded the widest scope consistent with the principles and features described herein

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It also will be understood that, as used herein, the term “comprising” or “comprises” is open-ended, and includes one or more stated elements, steps and/or functions without precluding one or more unstated elements, steps and/or functions. The term “and/or” includes any and all combinations of one or more of the associated listed items.

It will be understood that, although the terms first, second, etc. may be used herein to describe various elements, these elements should not be limited by these terms. These terms are only used to distinguish one element from another element. Thus, a first element discussed below could be termed a second element without departing from the scope of the present inventive concepts.

It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of all combinations and subcombinations of the embodiments described herein, and of the manner and process of making and using them, and shall support claims to any such combination or subcombination.

In the drawings and specification, there have been disclosed embodiments of the disclosure and, although specific terms are employed, they are used in a generic and descriptive sense only and not for purposes of limitation, the scope of the present disclosure being set forth in the following claims.

1. A Light Detection and Ranging (LIDAR) circuit, comprising:
a non-transitory memory device comprising a first memory and a second memory; and
at least one control circuit configured to:
execute first memory storage operations to store data indicated by detection signals received from one or more photodetector elements in the first memory during a time between pulses of an emitter signal output from a LIDAR emitter element; and
execute second memory storage operations to include previous data indicated by previous detection signals received from the one or more photodetector elements, which was stored in the first memory, in respective memory bins of the second memory,
wherein the at least one control circuit is configured to execute the first and second memory storage operations at least partially concurrently.

2. The LIDAR circuit of claim 1, wherein execution of the second memory storage operations comprises at least one of:
executing the second memory storage operations during execution of the first memory storage operations;
performing read, modify, and write operations to include the previous data in the respective memory bins responsive to a common precharge operation; or
wherein the second memory is partitioned into respective memory banks, addressing the respective memory bins of each of the respective memory banks in parallel.

3. The LIDAR circuit of claim 2, wherein the first memory comprises a pipeline memory, the second memory comprises a main memory, and the non-transitory memory device further comprises a temporary memory, and
wherein the second memory storage operations comprise retrieving the previous data from the temporary memory and integrating the previous data in the respective memory bins of the main memory.

4. The LIDAR circuit of claim 3, wherein the at least one control circuit is further configured to execute third memory storage operations to transfer the previous data from the pipeline memory to the temporary memory before execution of the first memory storage operations.

5. The LIDAR circuit of claim 3, wherein at least one control circuit is further configured to execute third memory storage operations to transfer the data from the pipeline memory to the temporary memory during the integrating of the previous data in the respective memory bins of the main memory.

6. The LIDAR circuit of claim 4 or 5, wherein the pipeline memory is configured to store the data with a bit length corresponding to a number of the respective memory banks, and wherein the temporary memory is configured to store at least a same number of bits as the pipeline memory.

7. The LIDAR circuit of claim 6, wherein the pipeline memory comprises a shift register, and a bit width of the shift register is less than or equal to a number of the one or more photodetector elements.

8. The LIDAR circuit of claim 4, wherein the at least one control circuit is configured to execute the first memory storage operations in series, and to execute the third memory storage operations in parallel.

9. The LIDAR circuit of claim 4, wherein the at least one control circuit is configured to execute the first memory storage operations responsive to a first clock signal, and to execute the third memory storage operations responsive to a second clock signal that is based on the first clock signal and a bit length of the pipeline memory or a number of the respective memory banks.

10. The LIDAR circuit of claim 3, wherein the first memory storage operations comprise sampling the data from the detection signals at a predetermined sampling rate and writing the data to respective bins of the pipeline memory.

11. The LIDAR circuit of claim 10, wherein the predetermined sampling rate corresponds to a period of a clock signal, and wherein the second memory storage operations are independent of the period of the clock signal.

12. The LIDAR circuit of claim 11, wherein the second memory storage operations are performed over two or more periods of the clock signal.

13. The LIDAR circuit of claim 2, wherein the at least one control circuit comprises respective logic circuits configured to execute the read, modify, and write operations for the respective memory banks in parallel, responsive to the common precharge operation.

14. The LIDAR circuit of claim 1, wherein the respective memory bins of the second memory comprise histogram data for an imaging distance subrange comprising up to an entirety of a distance range corresponding to the time between the pulses of the emitter signal.

15. A Light Detection and Ranging (LIDAR) detector circuit, comprising:
one or more photodetector elements defining a LIDAR detector pixel;
a pipeline memory device;
a main memory device; and
at least one control circuit configured to execute first and second memory storage operations to store current and previous data indicated by detection signals received from the LIDAR detector pixel in the pipeline and main memory devices, respectively,
wherein the at least one control circuit is configured to execute the first memory storage operations responsive to a first clock signal, and is configured to execute the second memory storage operations independent of a period of the first clock signal.

16. The LIDAR detector circuit of claim 15, further comprising:
a temporary memory device,
wherein the second memory storage operations comprise retrieving the previous data from the temporary memory device and integrating the previous data in the main memory device.

17. The LIDAR detector circuit of claim 16, wherein the at least one control circuit is configured to execute the second memory storage operations at least partially concurrently with execution of the first memory storage operations.

18. The LIDAR detector circuit of claim 15, wherein the main memory is partitioned into respective memory banks, and execution of the second memory storage operations comprises addressing respective memory bins of each of the respective memory banks in parallel.

19. The LIDAR detector circuit of claim 18, wherein execution of the second memory storage operations comprises performing read, modify, and write operations to include the previous data in respective memory bins of the main memory responsive to a common precharge operation.

20. The LIDAR detector circuit of claim 19, wherein the at least one control circuit comprises respective logic circuits configured to perform the read, modify, and write operations for the respective memory banks in parallel, responsive to the common precharge operation.

21. The LIDAR detector circuit of claim 16, wherein the at least one control circuit is further configured to execute third memory storage operations to transfer the previous data from the pipeline memory device to the temporary memory device before execution of the first memory storage operations.

22. The LIDAR detector circuit of claim 16, wherein the at least one control circuit is further configured to execute third memory storage operations to transfer the current data from the pipeline memory to the temporary memory device during execution of the second memory storage operations.

23. The LIDAR detector circuit of claim 21, wherein the at least one control circuit is configured to execute the third memory storage operations responsive to a second clock signal that is based on the first clock signal and a number of respective memory banks of the main memory.

24. The LIDAR detector circuit of claim 15, wherein the first memory storage operations comprise sampling the data from the detection signals at a predetermined sampling rate that corresponds to the period of the first clock signal and writing the data to respective bins of the pipeline memory device.

25. The LIDAR detector circuit of claim 15, wherein the second memory storage operations are performed over two or more periods of the first clock signal during a time between pulses of an emitter signal output from a LIDAR emitter element.

26. A method of operating a Light Detection and Ranging (LIDAR) detector circuit, the method comprising:
performing, by at least one control circuit coupled to a non-transitory memory device comprising a first memory and a second memory, operations comprising:
executing first memory storage operations to store, in the first memory, data indicated by detection signals received from one or more photodetector elements during a time between pulses of an emitter signal output from a LIDAR emitter element; and
at least partially concurrently with executing the first memory storage operations, executing second memory storage operations to include, in respective memory bins of the second memory, previous data indicated by previous detection signals received from the one or more photodetector elements, which was stored in the first memory.

27. The method of claim 26, wherein executing the second memory storage operations comprises at least one of:
executing the second memory storage operations during the execution of the first memory storage operations;
performing read, modify, and write operations to include the previous data in the respective memory bins responsive to a common precharge operation; or
wherein the second memory is partitioned into respective memory banks, addressing the respective memory bins of each of the respective memory banks in parallel.

28. The method of claim 27, wherein the first memory comprises a pipeline memory, the second memory comprises a main memory, and the non-transitory memory device further comprises a temporary memory, and wherein executing the second memory storage operations further comprises:
retrieving the previous data from the temporary memory and integrating the previous data in the respective memory bins of the main memory.

29. The method of claim 28, wherein the operations further comprise:
executing third memory storage operations to transfer the previous data from the pipeline memory to the temporary memory before execution of the first memory storage operations.

30. The method of claim 28, wherein the operations further comprise:
executing third memory storage operations to transfer the data from the pipeline memory to the temporary memory during the integrating of the previous data in the respective memory bins of the main memory.

31. The method of claim 30, wherein executing the first memory storage operations is responsive to a first clock signal, and executing the second memory storage operations is independent of a period of the first clock signal.

32. The method of claim 31, wherein executing the third memory storage operations is responsive to a second clock signal that is based on the first clock signal and a bit length of the pipeline memory or a number of the respective memory banks.

33. The LIDAR circuit of claim 14, wherein the one or more photodetector elements comprise single-photon avalanche detectors (SPADs), and wherein the data and/or the previous data comprises photon counts indicated by the detection signals corresponding to portions of the imaging distance subrange.

34. The LIDAR detector circuit of claim 16, wherein the pipeline memory, the main memory, and/or the temporary memory comprises a static random access memory (SRAM) or a dynamic random access memory (DRAM).

35. A LIDAR system comprising the LIDAR circuit of claim 1, wherein the LIDAR system is configured to be coupled to an autonomous vehicle such that the LIDAR emitter element and the one or more photodetector elements are oriented relative to an intended direction of travel of the autonomous vehicle.
